(19) United States
(12) Patent Application Publication
(10) Pub. No.: US 2024/0218296 A1
(43) Pub. Date: Jul. 4, 2024

(54) CLEANING LIQUID

(71) Applicant: KYOCERA Document Solutions Inc., Osaka (JP)

(72) Inventor: Motonobu SUGIMOTO, Osaka (JP)

(73) Assignee: KYOCERA Document Solutions Inc., Osaka (JP)

(21) Appl. No.: 18/391,871

(22) Filed: Dec. 21, 2023

(30) Foreign Application Priority Data
Dec. 28, 2022 (JP) 2022-211792

(51) Int. Cl. C11D 3/37

(52) U.S. Cl. CPC C11D 3/3707; C11D 2111/22

(57) ABSTRACT

A cleaning liquid contains an alkylene glycol dialkyl ether. The alkylene glycol dialkyl ether has a C log P of 1.00 or more but 3.00 or less.

### INCORPORATION BY REFERENCE

This application is based on and claims the benefit of priority from Japanese Patent Application No. 2022-211792 filed on Dec. 28, 2022, the contents of which are hereby incorporated by reference.

### BACKGROUND

The present disclosure relates to a cleaning liquid.

In inkjet recording apparatuses, recording heads are required to offer stable ejection performance for a long period (hence high ejection stability). Sustaining the ejection performance of recording heads requires the cleaning of the ink ejection surfaces of the recording heads. For example, according to a known method of cleaning the ejection surface of a recording head, a cleaning liquid is fed to the ink ejection surface of a recording head and then the ink ejection surface of the recording head is wiped with a wiping blade.

Inkjet recording apparatuses often use an ink containing a resin component (a dispersion resin and a binder resin) for satisfactory dispersion stability of pigments and reliable fixing of pigments on a recording medium.

### SUMMARY

According to the present disclosure, a cleaning liquid contains an alkylene glycol dialkyl ether. The alkylene glycol dialkyl ether has a C log P of 1.00 or more but 3.00 or less

This and other objects of the present disclosure, and the specific benefits obtained according to the present disclosure, will become apparent from the description of embodiments which follows.

### DETAILED DESCRIPTION

An embodiment of the present disclosure will be described below. Prior to a description of the embodiment, the known technology will be discussed.

With the known technology, forming an image using an ink containing a resin component may result in the resin component adhering to the ink ejection surface of a recording head, degrading the recording head's ejection performance. The resin component firmly adheres to the ink ejection surface of the recording head, and thus is difficult to remove with a known cleaning liquid. For effective removal of such resin components, cleaning liquids with high cleaning performance have been studied.

Known cleaning liquids with comparatively high cleaning performance include, for example, one containing a highly hydrophobic organic solvent and one with a surface tension reduced by addition of an surfactant. Also proposed as another known cleaning liquid is one containing a non-ionic surfactant, a first water-soluble organic solvent with a solubility parameter (SP value) of 13 or more, a second water-soluble organic solvent with a solubility parameter (SP value) less than 12, and water.

Unfortunately, none of the known cleaning liquids mentioned above has cleaning performance sufficient to remove resin components.

Made against the background discussed above, the present disclosure is aimed at providing a cleaning liquid with high cleaning performance.

In the present description, a static surface tension will be given as a value determined at 25° C. by the Wilhelmy method (plate method) on a surface tension tester (e.g., “Automatic Surface Tensiometer DY-300” manufactured by Kyowa Interface Science Co., Ltd.). In the present description, “acrylic” and “methacrylic” are occasionally referred to collectively as “(meth)acrylic.” In the present description, any ingredient may be a single substance or a combination of two or more substances.

### <Cleaning Liquid>

Now, a cleaning liquid according to the present disclosure will be described. The cleaning liquid of the present disclosure contains an alkylene glycol dialkyl ether. The alkylene glycol dialkyl ether has a C log P of 1.00 or more but 3.00 or less. Preferably, the cleaning liquid of the present disclosure further contains water. The cleaning liquid of the present disclosure may further contain a surfactant.

A C log P is an expected value of an octanol/water partition coefficient log P (more specifically, 1-octanol/water partition coefficient log P), which is a value indicating the hydrophilicity or hydrophobicity of a compound. The octanol/water partition coefficient log P is the logarithm of an octanol/water partition coefficient. The C log P can be calculated, for example, with “ChemDraw” manufactured by PerkinElmer, Inc. A higher value of a C log P indicates higher hydrophobicity.

The cleaning liquid of the present disclosure is suitable as a cleaning liquid used for the cleaning of, for example, a recording head (more specifically, its ink ejection surface) in an inkjet recording apparatus. The recording head may be a line recording head or a serial recording head. When used, the cleaning liquid of the present disclosure is, for example, applied to the ink ejection surface of the recording head. Examples of methods of applying the cleaning liquid of the present disclosure to the ink ejection surface of the recording head includes a first method of feeding the cleaning liquid of the present disclosure to the ink ejection surface and then spreading it over the ink ejection surface with a wiping blade, and a second method of feeding the cleaning liquid of the present disclosure over the ink ejection surface with a spray. In the first method, the wiping blade wipes with a linear pressure of, for example, 5 N/m or more but 20 N/m or less. A preferred material for the wiping blade is rubber.

The cleaning liquid of the present disclosure is preferably used to clean a recording head that ejects a water-soluble ink containing a resin component (e.g., a dispersion resin or a binder resin). Examples of the resin component include (meth)acrylic resin, styrene-(meth)acrylic resin, urethane resin, polyester resin, and olefin resin. The content of the resin component in the water-soluble ink is, for example, 0.1% by mass or more but 5.0% by mass or less.

Composed as described above, the cleaning liquid of the present disclosure offers high cleaning performance. The reasons are inferred to be as follows. The cleaning liquid of the present disclosure contains an alkylene glycol dialkyl ether with a C log P of 1.00 or more but 3.00 or less (in the following description, occasionally referred to as the specific organic solvent). The specific organic solvent has comparatively high hydrophobicity among water-soluble organic solvents. An organic solvent with high hydrophobicity has good affinity with a resin component. Accordingly, when brought into contact with a resin component adhering to the ink ejection surface of a recording head, the cleaning liquid of the present disclosure is easily absorbed by the resin component. Absorbing the specific organic solvent, the resin component swells and deforms, and becomes easier to peel off the ink ejection surface. Thus, containing the specific organic solvent, the cleaning liquid of the present disclosure can make the resin component adhering to the ink ejection surface absorb the specific organic solvent and thereby promote the peeling of the resin component off the ink ejection surface. Hence, the cleaning liquid of the present disclosure offers high cleaning performance. Note however that an organic solvent with an excessively high C log P (e.g., a C log P more than 3.00) has extremely low water solubility. For this reason, in the cleaning liquid of the present disclosure, the alkylene glycol dialkyl ether is given a C log P of 3.00 or less. The cleaning liquid according to the present disclosure will now be described in detail.

### [Static Surface Tension]

The cleaning liquid of the present disclosure has a static surface tension of preferably 20.0 mN/m or more but 40.0 mN/m or less, and more preferably 25.0 mN/m or more but 30.0 mN/m or less. Giving the cleaning liquid of the present disclosure a static surface tension of 20.0 mN/m or more but 40.0 mN/m or less makes it easy for the cleaning liquid of the present disclosure to permeate through minute gaps present between the cleaning target (e.g., an ink ejection surface) and soil. Thus, the cleaning liquid of the present disclosure provides higher cleaning performance.

### [Alkylene Glycol Dialkyl Ether]

An alkylene glycol dialkyl ether gives the cleaning liquid of the present disclosure high cleaning performance. The alkylene glycol dialkyl ether has a C log P of 1.00 or more but 3.00 or less, and preferably 1.00 or more but 1.50 or less. An alkylene glycol dialkyl ether with a C log P of 1.00 or more gives the cleaning liquid of the present disclosure high cleaning performance. An alkylene glycol dialkyl ether with a C log P of 3.00 or less helps secure satisfactory compatibility of the alkylene glycol dialkyl ether with other ingredients (e.g., water).

The alkylene glycol dialkyl ether is preferably a polyalkylene glycol dialkyl ether, and more preferably a compound represented by the general formula below.

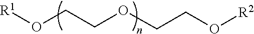

In the general formula, n represents an integer of 1 to 10. The integer n is preferably one or more but five or less, and is more preferably one or two. R1 and R2 each represent an alkyl group with a carbon number of 1 to 10. The alkyl groups R1 and R2 are each preferably an alkyl group with a carbon number of 1 to 5, preferably methyl group, ethyl group, propyl group (specifically n-propyl group or isopropyl group), or butyl group (specifically n-butyl group, sec-butyl group, isobutyl group, or tert-butyl group), and more preferably methyl group or n-butyl group.

Specific examples of the alkylene glycol dialkyl ether include diethylene glycol butyl methyl ether (C log P: 1.19) and triethylene glycol butyl methyl ether (C log P: 1.01). The alkylene glycol dialkyl ether is preferably diethylene glycol butyl methyl ether or triethylene glycol butyl methyl ether.

In the cleaning liquid of the present disclosure, the content of the alkylene glycol dialkyl ether (specifically, an alkylene glycol dialkyl ether with a C log P of 1.00 or more but 3.00 or less) is preferably 1.0% by mass or more but 10.0% by mass or less, more preferably 1.5% by mass or more but 7.0% by mass or less, and further preferably 4.0% by mass or more but 6.0% by mass or less. A content of the alkylene glycol dialkyl ether of 1.0% by mass or more gives the cleaning liquid of the present disclosure still higher cleaning performance. A content of the alkylene glycol dialkyl ether of 10.0% by mass or less makes it easy to secure the compatibility of the alkylene glycol dialkyl ether with other ingredients (e.g., water).

### [Water]

Water is, for example, the chief ingredient of the cleaning liquid of the present disclosure. Containing water as the chief ingredient, the cleaning liquid of the present disclosure is environment-friendly. The content of water in the cleaning liquid of the present disclosure is preferably 80.0% by mass or more but 99.0% by mass or less, and more preferably 90.0% by mass or more but 98.0% by mass or less.

Preferably, the cleaning liquid of the present disclosure chiefly contains an alkylene glycol dialkyl ether with a C log P of 1.00 or more but 3.00 or less along with water. In the cleaning liquid of the present disclosure, the total content of the alkylene glycol dialkyl ether with a C log P of 1.00 or more but 3.00 or less and water is preferably 90.0% by mass or more, more preferably 95.0% by mass or more, and further preferably 99.0% by mass or more.

### [Surfactant]

A surfactant optimizes the static surface tension of the cleaning liquid of the present disclosure. The surfactant is preferably a non-ionic surfactant.

Examples of non-ionic surfactants include acetylene glycol surfactants (surfactants containing an acetylene glycol compound), silicone surfactants (surfactants containing a silicone compound), and fluorine surfactants (surfactants containing a fluororesin or a fluorine compound). Examples of acetylene glycol surfactants include ethylene oxide adducts of acetylene glycol and propylene oxide adducts of acetylene glycol. A preferred non-ionic surfactant is an acetylene glycol surfactant.

The content of the surfactant in the cleaning liquid of the present disclosure is preferably 0.1% by mass or more but 2.0% by mass or less, and more preferably 0.3% by mass or more but 0.7% by mass or less. A content of the surfactant of 0.1% by mass or more but 2.0% by mass or less helps further optimize the static surface tension of the cleaning liquid of the present disclosure.

### [Additives]

As necessary, the cleaning liquid of the present disclosure may be blended with any other known additives (specifically, agents for dissolution stabilization, drying prevention, oxidation prevention, viscosity adjustment, pH adjustment, and mold prevention). Preferably, the cleaning liquid of the present disclosure does not contain an alkylene glycol dialkyl ether with a C log P less than 1.00 or more than 3.00. In the cleaning liquid of the present disclosure, the content of an alkylene glycol dialkyl ether with a C log P less than 1.00 or more than 3.00 is preferably 3.0% by mass or less, more preferably 0.5% by mass or less, and further preferably 0.0% by mass.

### [Manufacturing Method of Cleaning Liquid]

The cleaning liquid of the present disclosure can be manufactured by blending an alkylene glycol dialkyl ether with a C log P of 1.00 or more but 3.00 or less with one or more other ingredients that are added as necessary (e.g., water and a surfactant).

### EXAMPLES

Practical examples of the present disclosure will now be presented. Those examples, however, are not meant to limit the present disclosure.

### [Measurement of Static Surface Tension]

The static surface tension was measured at 25° C. by the Wilhelmy method (plate method) on a surface tension tester (e.g., “Automatic Surface Tensiometer DY-300” “manufactured by Kyowa Interface Science Co., Ltd.).

### [Ink]

For evaluation, a known ink (I-1) containing a resin component was used.

### [Organic Solvent]

Used as an organic solvent to prepare cleaning liquids were the compounds listed in Table 1 below. Table 1 gives, for each organic solvent, the C log P calculated with “ChemDraw” manufactured by PerkinElmer, Inc. and the solid-liquid surface tension measured by the method described below. It has been found that a preferred solid-liquid surface tension of an organic solvent is 15.0 mN/m or less.

### [Measurement of Solid-Liquid Surface Tension]

The ink (I-1) mentioned above was applied over a thin sheet of stainless steel (thin sheet of SUS304) by spin-coating (the amount applied: 0.7 L/cm2). Subsequently, the thin sheet of stainless steel was left at rest for 24 hours at 60° C. to dry the applied ink (I-1). The drying reduced the mass of the ink (I-1) by about 85% by mass (a dryness factor of about 85%). In this way, a thin sheet of stainless steel having a dry coating of the ink (I-1) formed over it was prepared.

In the environment of 25° C., water was dropped onto the dry coating on the thin sheet of stainless steel mentioned above on a contact angle tester (“OCA40” manufactured by EKO Instruments Co., Ltd.). One second after an organic solvent reached the dry coating, the angle of contact A of the drop of water with respect to the dry coating was measured on the contact angle tester mentioned above. Then, by a method similar to that used to measure the angle of contact A, but using, instead of water, diiodine methane or a measurement target (the organic solvents listed in Table 1 below), the angle of contact B of a drop of diiodine methane with respect to the dry coating and the angle of contact C of a drop of the organic solvents listed in Table 1 below with respect to the dry coating were measured. Based on the angles of contact A and B, the surface free energy of the dry coating was calculated. Then, based on the surface free energy of the dry coating and the angle of contact C, the solid-liquid surface tension of each organic solvent with respect to the dry coating was calculated.

TABLE 1

| | | Solid-Liquid |
|---|---|---|
| | | Surface |
| | | Tension |
| Organic Solvent | ClogP | [mN/m] |
| Diethylene glycol butyl methyl ether | 1.19 | 11.1 |
| Triethylene glycol butyl methyl ether | 1.01 | 8.1 |
| Tripropylene glycol monomethyl ether | −0.03 | 12.2 |
| Dipropylene glycol dimethyl ether | 0.36 | 15.8 |
| Diethylene glycol butyl ether | 0.67 | 7.5 |
| Triethylene glycol butyl ether | 0.49 | 4.0 |
| Diethylene glycol ethyl ether | −0.39 | 7.1 |
| Pentylene glycol | 0.00 | 3.4 |
| 2-Pyrrolidone | −0.97 | 0.2 |
| Propylene glycol | −1.06 | 4.6 |
| 1,3-Propanediol | −1.04 | 13.4 |
| Glycerol | −1.54 | 39.0 |

In Table 1, diethylene glycol butyl methyl ether and triethylene glycol butyl methyl ether were alkylene glycol dialkyl ethers with a C log P of 1.00 or more but 3.00 or less.

### <Preparation of Cleaning Liquids>

Cleaning Liquids (A)-(D) to be used in practical examples and Cleaning Liquids (E)-(S) to be used in comparative examples were prepared in the following manners.

### [Cleaning Liquid (A)]

Cleaning Liquid (A) was prepared by fully mixing 5.0 parts by mass of diethylene glycol butyl methyl ether and 95.0 parts by mass of ion-exchange water (the total amount being 100.0 parts by mass).

### [Cleaning Liquids (B)-(S)]

Cleaning Liquids (B)-(S) were prepared in a manner similar to that for Cleaning Liquid (A) except that the ingredients used and their amounts mixed were changed as shown in Tables 2 to 4 below. In Tables 2 to 4 below, the “surfactant” was an acetylene glycol surfactant (“Olfin® EXP4300” manufactured by Nissin Chemical Co., Ltd., ionicity: non-ionic, effective ingredient density: 60% by mass, solvent: propylene glycol and dipropylene glycol).

### <Evaluation>

The cleaning performance of Cleaning Liquids (A)-(S) was evaluated in the following manner. The evaluation results are shown in Tables 2 to 4 below.

### Practical Example 1

The ink (I-1) described previously, 2 mL of it, was dropped onto a thin sheet of stainless steel (a thin sheet of SUS304) and was applied over it by spin-coating (spinning speed: 2000 rpm, spinning duration: 3 seconds). Subsequently, the thin sheet of stainless steel was left at rest for 24 hours at 60° ° C. to dry the applied ink (I-1). In this way, a thin sheet of stainless steel having a dry coating of the ink (I-1) formed over its entire surface was prepared.

Using a pipetter, 0.1 mL of the evaluation target (in Practical Example 1, Cleaning Liquid (A)) was dropped onto the thin sheet of stainless steel. Subsequently, using a rubber blade, the dry coating on the thin sheet of stainless steel was wiped with a linear pressure of 10 N/m. For the thin sheet of stainless steel after the wiping, the area X where the dry coating was removed and the base material (stainless steel) was exposed (i.e., the area where the cleaning liquid successfully removed the dry coating) was measured. The percentage (removal ratio) of the area X with respect to the total area of the thin sheet of stainless steel was taken as the evaluation value of cleaning performance. Cleaning performance was evaluated according to the following criteria.

### (Criteria for Cleaning Performance)

A (excellent): a removal ratio of 95% or more.

B (good): a removal ratio of 90% or more but less than 95%.

C (poor): a removal ratio of 70% or more but less than 90%.

D (bad): a removal ratio less than 70%.

### Practical Examples 2-5 and Comparative Examples 1-16

Practical Examples 2-5 were carried out in a manner similar to that for Practical Example 1 except that the ink and the cleaning liquid used were changed as shown in Table 2 below.

TABLE 2

| | | Practical Example | | | | |
|---|---|---|---|---|---|---|
| | | 1 | 2 | 3 | 4 | 5 |
| Cleaning Liquid | | A | A | B | C | D |
| Organic | Diethylene glycol butyl | 5.0 | 5.0 | 3.0 | 3.0 | — |
| Solvent | methyl ether | | | | | |
| | Triethylene glycol butyl | — | — | — | — | 5.0 |
| | methyl ether | | | | | |
| | Tripropylene glycol | — | — | — | — | — |
| | monomethyl ether | | | | | |
| | Dipropylene glycol | — | — | — | — | — |
| | dimethyl ether | | | | | |
| | Diethylene glycol butyl | | | | | — |
| | ether | | | | | |
| | Triethylene glycol butyl | — | — | — | — | — |
| | ether | | | | | |
| | Diethylene glycol ethyl | — | — | — | — | — |
| | ether | | | | | |
| | Pentylene glycol | — | — | — | — | — |
| | 2-Pyrrolidone | — | — | — | — | — |
| | Propylene glycol | — | — | — | — | — |
| | 1,3-Propanediol | — | — | — | — | — |
| | Glycerol | — | — | — | — | — |

| | | | | | |
|---|---|---|---|---|---|
| Surfactant | — | — | — | 0.5 | — |
| Ion-Exchange Water | 95.0 | 95.0 | 97.0 | 96.5 | 95.0 |
| Surface Tension | 35.7 | 35.7 | 43.8 | 28.1 | 39.3 |
| Ink | I-1 | I-2 | I-1 | I-1 | I-1 |
| Evaluation Result | A | A | B | A | A |

Comparative Examples 1-8 were carried out in a manner similar to that for Practical Example 1 except that the ink and the cleaning liquid used were changed as shown in Table 3 below.

TABLE 3

| | | Comparative Example | | | | | | | |
|---|---|---|---|---|---|---|---|---|---|
| | | 1 | 2 | 3 | 4 | 5 | 6 | 7 | 8 |
| Cleaning Liquid | | E | E | F | G | H | I | J | K |
| Organic | Diethylene glycol | — | — | — | — | — | — | — | — |
| Solvent | butyl methyl ether | | | | | | | | |
| | Triethylene glycol | — | — | — | — | — | — | — | — |
| | butyl methyl ether | | | | | | | | |
| | Tripropylene glycol | 5.0 | 5.0 | 5.0 | — | — | — | — | — |
| | monomethyl ether | | | | | | | | |
| | Dipropylene glycol | — | — | — | 5.0 | 5.0 | — | — | — |
| | dimethyl ether | | | | | | | | |
| | Diethylene glycol | — | — | — | — | — | 5.0 | 5.0 | — |
| | butyl ether | | | | | | | | |
| | Triethylene glycol | — | — | — | — | — | — | — | 5.0 |
| | butyl ether | | | | | | | | |
| | Diethylene glycol | — | — | — | — | — | — | — | — |
| | ethyl ether | | | | | | | | |
| | Pentylene glycol | — | — | — | — | — | — | — | — |
| | 2-Pyrrolidone | — | — | — | — | — | — | — | — |
| | Propylene glycol | — | — | — | — | — | — | — | — |
| | 1,3-Propanediol | — | — | — | — | — | — | — | — |
| | Glycerol | — | — | — | — | — | — | — | — |

| | | | | | | | | |
|---|---|---|---|---|---|---|---|---|
| Surfactant | — | — | 0.5 | — | 0.5 | — | 0.5 | — |
| Ion-Exchange Water | 95.0 | 95.0 | 94.5 | 95.0 | 94.5 | 95.0 | 94.5 | 95.0 |
| Surface Tension | 48.1 | 48.1 | 27.1 | 48.2 | 27.6 | 40.9 | 27.3 | 43.9 |
| Ink | I-1 | I-2 | I-1 | I-1 | I-1 | I-1 | I-1 | I-1 |
| Evaluation Result | D | D | D | D | D | D | D | D |

Comparative Examples 9-16 were carried out in a manner similar to that for Practical Example 1 except that the ink and the cleaning liquid used were changed as shown in Table 4 below.

TABLE 4

| | | Comparative Example | | | | | | | |
|---|---|---|---|---|---|---|---|---|---|
| | | 9 | 10 | 11 | 12 | 13 | 14 | 15 | 16 |
| Cleaning Liquid | | L | M | N | O | P | Q | R | S |
| Organic | Diethylene glycol | — | — | — | — | — | — | — | — |
| Solvent | butyl methyl ether | | | | | | | | |
| | Triethylene glycol | — | — | — | — | — | — | — | — |
| | butyl methyl ether | | | | | | | | |
| | Tripropylene glycol | — | — | — | — | — | — | — | — |
| | monomethyl ether | | | | | | | | |
| | Dipropylene glycol | — | — | — | — | — | — | — | — |
| | dimethyl ether | | | | | | | | |
| | Diethylene glycol | — | — | — | — | — | — | — | — |
| | butyl ether | | | | | | | | |
| | Triethylene glycol | 5.0 | — | — | — | — | — | — | — |
| | butyl ether | | | | | | | | |
| | Diethylene glycol | — | 5.0 | — | — | — | — | — | — |
| | ethyl ether | | | | | | | | |
| | Pentylene glycol | — | — | 5.0 | — | — | — | — | — |
| | 2-Pyrrolidone | — | — | — | 5.0 | — | — | — | — |
| | Propylene glycol | — | — | — | — | 5.0 | — | — | — |
| | 1,3-Propanediol | — | — | — | — | — | 5.0 | — | — |
| | Glycerol | — | — | — | — | — | — | 5.0 | 5.0 |

| | | | | | | | | |
|---|---|---|---|---|---|---|---|---|
| Surfactant | 0.5 | — | — | — | — | — | — | 0.5 |
| Ion-Exchange Water | 94.5 | 95.0 | 95.0 | 95.0 | 95.0 | 95.0 | 95.0 | 94.5 |
| Surface Tension | 26.8 | 58.7 | 47.5 | 66.3 | 66.7 | 69.8 | 73.0 | 25.7 |
| Ink | I-1 | I-1 | I-1 | I-1 | I-1 | I-1 | I-1 | I-1 |
| Evaluation Result | D | D | D | D | D | D | D | D |

The cleaning liquids used in Practical Examples 1-5 contained an alkylene glycol dialkyl ether. The alkylene glycol dialkyl ether had a C log P of 1.00 or more but 3.00 or less. The cleaning liquids used in Practical Examples 1-5 exhibited high cleaning performance.

The cleaning liquids used in Practical Examples 1, 2, 4, and 5 had a static surface tension of 20.0 mN/m or more but 40.0 mN/m or less. Compared with the cleaning liquid used in Practical Example 3 (with a static surface tension more than 40.0 mN/m), the cleaning liquids used in Practical Examples 1, 2, 4, and 5 exhibited particularly high cleaning performance.

In contrast, the cleaning liquids used in Comparative Examples 1-16 contained an organic solvent with a C log P less than 1.00. As a result, Comparative Examples 1-16 resulted in poor cleaning performance. As will be understood from Comparative Examples 3, 5, 7, 9, and 16, a static surface tension of 20.0 mN/m or more but 40.0 mN/m or less was not sufficient to obtain satisfactory cleaning performance.

The cleaning liquid according to the present disclosure offers high cleaning performance.

The cleaning liquid according to the present disclosure can be used for the cleaning of recording heads in inkjet recording apparatuses.

What is claimed is:

1. A cleaning liquid comprising an alkylene glycol dialkyl ether, wherein
the alkylene glycol dialkyl ether has a C log P of 1.00 or more but 3.00 or less.

2. The cleaning liquid according to claim 1, wherein
the alkylene glycol dialkyl ether contains diethylene glycol butyl methyl ether or triethylene glycol butyl methyl ether.

3. The cleaning liquid according to claim 1, wherein
a content of the alkylene glycol dialkyl ether is 1.0% by mass or more but 10.0% by mass or less.

4. The cleaning liquid according to claim 1, wherein
the cleaning liquid has a static surface tension of 20.0 mN/m or more but 40.0 mN/m or less.

5. The cleaning liquid according to claim 1, wherein
the cleaning liquid is used for cleaning of a recording head in an inkjet recording apparatus.
